(19) United States
(12) Patent Application Publication
(10) Pub. No.: US 2013/0213888 A1
(43) Pub. Date: Aug. 22, 2013

(54) COOLING TOWER BLOW-DOWN, GROUNDWATER AND WASTEWATER RE-USE PROCESS AND SYSTEM

(71) Applicant: TEMPEST ENVIRONMENTAL SYSTEMS, INC., (US)

(72) Inventor: Gerard F. Tempest, JR., Chapel Hill, NC (US)

(73) Assignee: TEMPEST ENVIRONMENTAL SYSTEMS, INC., Durham, NC (US)

(21) Appl. No.: 13/707,814

(22) Filed: Dec. 7, 2012

Related U.S. Application Data
(63) Continuation-in-part of application No. 13/399,836, filed on Feb. 17, 2012, now abandoned.

(51) Int. Cl. C02F 9/00

(52) U.S. Cl. CPC C02F 9/00
USPC 210/638; 210/650; 210/652; 210/639

(57) ABSTRACT

A cooling tower blow-down, groundwater and wastewater re-use process and system is provided, which system may further include a cooling tower evaporation recovery system and process. Thus, blow-down from cooling equipment may be reused by appropriate treatment of the blow-down water, or treatment of other sources of water such as groundwater or wastewater, for use as make-up water in a cooling tower or other cooling equipment, and the capture of evaporation from cooling equipment is conducted to increase the efficiency and lower costs in the operation of such equipment.

### CROSS-REFERENCE TO RELATED APPLICATION

This application is a continuation-in-part under 35 U.S.C. §120 of U.S. patent application Ser. No. 13/399,836 filed Feb. 17, 2012 in the name of Gerard F. Tempest, Jr. for “COOLING TOWER BLOW-DOWN, GROUNDWATER AND WASTEWATER RE-USE PROCESS AND SYSTEM.” The disclosure of U.S. patent application Ser. No. 13/399,836 is hereby incorporated herein by reference, in its respective entirety, for all purposes.

### FIELD OF THE DISCLOSURE

The present disclosure relates to a system and method for the treatment of blow-down from cooling equipment, such as a cooling tower, to provide water which may be re-used as make-up water for the cooling tower. The present disclosure further relates to a system and method for the treatment of groundwater, wastewater or other water source to provide water which may be used as additional make-up water for a cooling tower.

The present disclosure further relates to a system and method for the recovery of evaporation from a cooling tower for reuse in make-up water for the cooling tower.

### DESCRIPTION OF THE RELATED ART

Cooling towers vary in size and design, but typically function to provide liberation of waste heat through evaporation of water. Cooling towers consume large volumes of water, usually supplied by municipalities, through the evaporation process. Because the evaporative loss is water containing <0.1 ppm dissolved solids, the water remaining in the cooling tower becomes concentrated with dissolved solids, which can lead to scaling, corrosive conditions and even biological fouling. Thus, the degree of water reuse of the blow-down in the cooling towers is limited by dissolved solids in the water. When the concentration of dissolved solids becomes high enough, the waste water, referred to as blow-down, is totally discharged from the cooling tower. Consequently, feed water, also known as make-up water, must be introduced into the cooling tower to replace the quantity lost to evaporation and blow-down.

The blow-down water is usually dumped into a sanitary drain. To avoid this and as a way of reducing total water cost, reuse of the blow-down is desirable; however, the water quality of the blow-down is such that the water must be treated prior to reuse. There are many well-known methods used for treatment of water, such as reverse osmosis, distillation, ion-exchange, chemical adsorption, coagulation, and filtering or retention. Particle filtration may be completed through the use of membranes or layers of granular materials. Other fluid purification techniques may involve chemical introduction which alters the state or chemical identity of the contaminant.

However, many of the known water treatment methods are costly or inefficient or do not result in water which is of adequate quality to be used as make-up water for a cooling tower.

In consequence, the art continues to seek improvements in the treatment or purification of water from cooling tower operations.

### SUMMARY OF THE DISCLOSURE

The present disclosure involves systems and methods for the recovery of water from cooling equipment. The disclosure further relates to the treatment of blow-down, groundwater and wastewater for re-use in cooling equipment or other uses.

In one aspect, the present disclosure relates to a water treatment system for treatment of blow-down to remove contaminants therefrom comprising a pretreatment zone arranged to receive the blow-down and to produce a pretreated water stream having an SDI less than or equal to about 1 and a turbidity of less than or equal to about 1 NTU; a membrane separation zone downstream of the pretreatment zone comprising a first membrane separation unit arranged to receive the pretreated water stream and pass the pretreated water stream through a first membrane unit to provide a first permeate stream and a first reject stream, and a second membrane separation unit arranged to receive the first reject stream and pass the first reject stream through a second membrane unit and provide a second permeate stream and a second reject stream; and a collection zone downstream of the membrane separation zone arranged to collect and combine the first permeate stream and the second permeate stream to provide a permeate product stream, wherein the ratio of the quantity of the permeate product stream produced to the quantity of the blow-down provided is greater than about 80%. The membrane separation zone in one aspect utilizes a reverse osmosis type membrane separation. The membrane separation zone in another aspect utilizes a nanofiltration type membrane separation. In other aspects, the membrane separation zone may comprise a combination of membrane separation systems.

In a further aspect, the disclosure relates to a method for treating blow-down to remove contaminants, comprising pretreating the blow-down to produce a pretreated water stream having an SDI less than or equal to about 1 and a turbidity of less than or equal to about 1 NTU; flowing the pretreated water stream into a first membrane separation unit to obtain a first permeate stream and a first reject stream; flowing the first reject stream into a second membrane separation unit to obtain a second permeate stream and a second reject stream; and combining the first permeate stream and the second permeate stream to form a permeate product stream, wherein the ratio of the quantity of the permeate product stream produced to the quantity of the blow-down provided is greater than about 80%.

In a further aspect, a water treatment system for recovering water from cooling equipment is provided comprising a cooling tower arranged to generate evaporate, utilize a make-up water stream and produce blow-down; a dehumidification zone coupled to the cooling tower and arranged to collect and condense evaporate generated by the cooling tower; a pretreatment zone arranged to receive blow-down and produce a pretreated water stream; a membrane separation zone downstream of the pretreatment zone comprising a first membrane separation unit arranged to receive the pretreated water stream and pass the pretreated water stream through a first membrane unit to provide a first permeate stream and a first reject stream, and a second membrane separation unit arranged to receive the first reject stream and pass the first reject stream through a second membrane unit and provide a second permeate stream and a second reject stream, and a collection zone downstream of the membrane separation zone arranged to collect and combine the first permeate stream and the second permeate stream to provide a permeate product stream, wherein the permeate product stream from the collection zone and the condensed evaporate from the dehumidification zone are combined and recycled to the cooling tower to provide at least a portion of the make-up water stream for the cooling tower.

Other aspects, features and embodiments of the disclosure will be more fully apparent from the ensuing disclosure and appended claims.

### BRIEF DESCRIPTION OF THE DRAWINGS

FIG. 1A is a process flow diagram illustrating a representative cooling tower operation. FIG. 1B is a process flow diagram of an exemplary cooling tower utilizing a water treatment system according to embodiments of the present disclosure.

FIG. 2 is a process flow diagram illustrating the constituent components of a detailed water treatment system according to one embodiment of the present disclosure.

FIG. 3 is a process flow diagram illustrating the constituent components of a detailed water treatment system according to another embodiment of the present disclosure.

### DETAILED DESCRIPTION AND PREFERRED EMBODIMENTS THEREOF

The present disclosure relates to a cooling tower blow-down, groundwater and wastewater re-use process and system, which further includes a cooling tower evaporation recovery system and process. Thus, the disclosure relates to the reuse of blow-down from cooling equipment by appropriate treatment of the blow-down water, treatment of other sources of water such as groundwater or wastewater, for use as make-up water in a cooling tower, and the capture of evaporation from cooling equipment to increase the efficiency and lower costs in the operation of such equipment. By way of the systems and methods of the disclosure, blow-down from a cooling tower may be treated and returned to the cooling tower with water quality suitable for use as make-up water. Such systems and methods result in substantial environmental and economic benefits.

The present disclosure provides a customizable, cost-effective, high efficiency process and system which enables recovery of treated water from the treatment system and process in excess of 80%. In one embodiment, the system includes a pretreatment zone and a membrane separation zone. In further embodiments, the system includes a pretreatment zone and a nanofiltration zone or a pretreatment zone and a reverse osmosis zone, or any combination thereof. In further embodiments, the system includes a disinfection zone. In additional embodiments, the system includes a rehumidification zone. These systems may be used to treat blow-down water, groundwater, wastewater, water from another source, or any combination thereof.

The disclosure provides a water treatment system for treatment of blow-down to remove contaminants therefrom comprising a pretreatment zone arranged to receive the blow-down and to produce a pretreated water stream having an SDI less than or equal to about 1 and a turbidity of less than or equal to about 1 NTU; a membrane separation zone downstream of the pretreatment zone comprising a first membrane separation unit arranged to receive the pretreated water stream and pass the pretreated water stream through a first membrane unit to provide a first permeate stream and a first reject stream, and a second membrane separation unit arranged to receive the first reject stream and pass the first reject stream through a second membrane unit and provide a second permeate stream and a second reject stream, and a collection zone downstream of the membrane separation zone arranged to collect and combine the first permeate stream and the second permeate stream to provide a permeate product stream, wherein the ratio of the quantity of the permeate product stream produced to the quantity of the blow-down provided is greater than about 80%, greater than about 85%, greater than about 90% or greater than about 95%, in specific embodiments.

In embodiments, the water treatment system is arranged such that the second reject stream is not recycled to the first or the second membrane separation unit. Recycling of one or more of the reject streams through the membrane separation zone, such as through one or more membrane separation unit, with or without supplementary treatment of the recycle stream or streams, is not necessary to achieve advantageous water recovery with the high efficiency systems and methods of the disclosure. Elimination of a reject recycle stream, which might have been thought necessary to achieve high efficiency and recovery, has unexpectedly been discovered to be possible, thereby achieving savings in capital equipment and operational costs.

In an embodiment, a method for treating blow-down to remove contaminants is provided comprising pretreating the blow-down to produce a pretreated water stream having an SDI less than or equal to about 1 and a turbidity of less than or equal to about 1 NTU; flowing the pretreated water stream into a first membrane separation unit to obtain a first permeate stream and a first reject stream; flowing the first reject stream into a second membrane separation unit to obtain a second permeate stream and a second reject stream; and combining the first permeate stream and the second permeate stream to form a permeate product stream, wherein the ratio of the quantity of the permeate product stream produced to the quantity of the blow-down provided is greater than about 80%; and wherein the second reject stream is not recycled to the first or the second membrane separation unit.

In other embodiments, methods for treating water are provided wherein the water comprises blow-down, ground water, waste water, treated sewage effluent or other source, or combinations thereof. In these embodiments, a method of treating water is provided comprising pretreating the water to produce a pretreated water stream having an SDI less than or equal to about 1 and a turbidity of less than or equal to about 1 NTU; flowing the pretreated water stream into a first membrane separation unit to obtain a first permeate stream and a first reject stream; flowing the first reject stream into a second membrane separation unit to obtain a second permeate stream and a second reject stream; and combining the first permeate stream and the second permeate stream to form a permeate product stream, wherein the ratio of the quantity of the permeate product stream produced to the quantity of the water provided is greater than about 80%; and wherein the second reject stream is not recycled to the first or the second membrane separation unit.

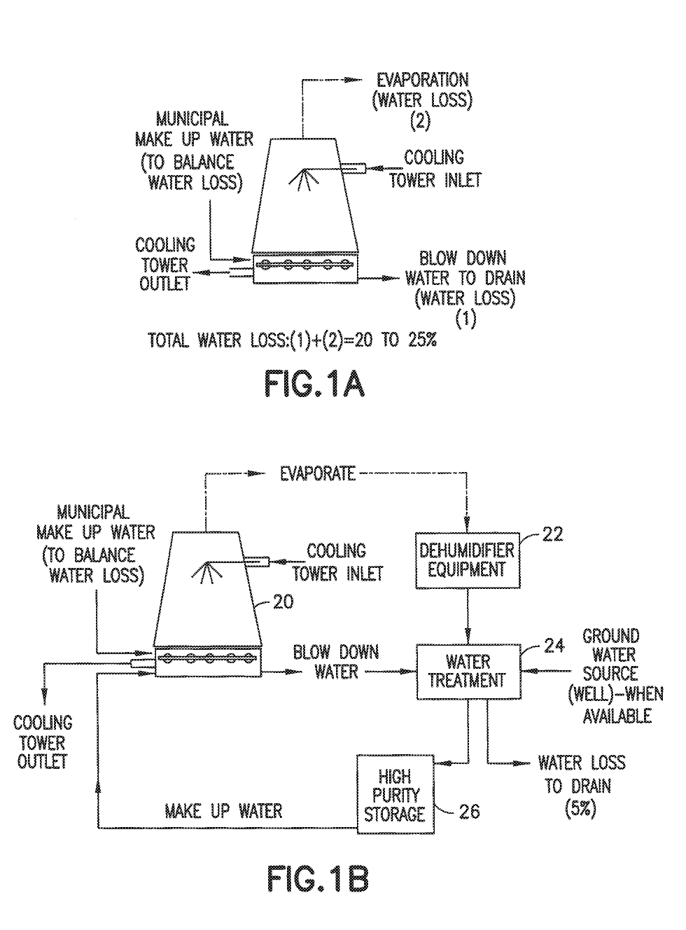

The water that is drained from cooling equipment to remove mineral build-up is called blow-down or bleed water. The cooling equipment that requires blow-down is most often such equipment as cooling towers, evaporative condensers, evaporative coolers, evaporative cooled air-conditioners and central boilers. These cooling systems rely on water evaporation to obtain the cooling effect. As the water evaporates, the mineral content of the remaining water increases in concentration. Once the mineral concentration reaches a predetermined level, the blow-down typically is discharged and replaced by make-up water containing less concentrated dissolved solids. As shown in FIG. 1A, a representative cooling tower operation, for example, may include an inlet for municipal make up water and a cooling tower inlet. Such a cooling tower typically will have a cooling tower outlet and an outlet for blow-down water to a drain. Evaporation from the cooling tower leads to water loss, as does the blow-down water outlet to a drain. The total water loss, for example, from evaporation (2) and blow-down water (1) may be result in a total water loss of about 20 to 25%.

The blow-down water typically contains such contaminants as dissolved minerals, chemicals, metals, or organic contaminants. By way of example, chemical additives may be put into the water used in cooling equipment. These chemical additives typically are employed to impede scaling, reduce pH levels and/or kill biological contaminates, and the like.

The quality of the water may be determined by a number of factors, including, but not limited to, pH, temperature, total suspended solids (TSS), turbidity, total dissolved solids (TDS), alkalinity, conductivity, hardness, microorganism levels or silt density index (SDI). The quality of the water is highly site-specific, with differing contaminants in the water depending on the initial water source, the additives and chemicals used in the cooling equipment, the process parameters of the cooling equipment operation, the number of cycles of concentration utilized in the cooling equipment and other variable factors.

The system and process of the present disclosure provides a customizable approach to reuse of blow-down water from cooling equipment. As provided herein in one embodiment of the disclosure, the blow-down water first is pretreated to obtain a quality of water which meets predetermined criteria and then a two stage membrane separation process is conducted to obtain water of a desired quality. By controlling the pretreatment steps to provide water of a particular quality, the membrane separation units can be operated at high efficiency with a low discharge at the drain. The operation of the herein described water treatment system provides (1) advantages of water savings since the blow-down water is recycled, and (2) sewer cost savings, since less water is sent to drain. In addition, in some aspects of the disclosure, the recycled blow-down water is combined with groundwater obtained locally in proximity to the cooling equipment such that no additional make-up water is required.

In addition, the membrane separation units require less cleaning since the water sent to the membrane separation zone has been pretreated and less scaling and fouling occurs compared to other systems. Moreover, since the water treated by the water treatment system of this disclosure is likely intended for use as recycle water for the cooling equipment, fewer chemicals are needed during operation of the cooling equipment, which provides additional savings.

Reverse osmosis units may be used for the membrane separation unit in the water treatment system. Nanofiltration units may optionally be used rather than reverse osmosis units where the water quality is such that a nanofiltration system will provide the desired water quality. Any number of membrane separation units may be used, including, for example, two, three, or more units, as required for a particular system.

The parameters for the quality of the water according to one aspect of the present disclosure are controlled such that SDI is less than or equal to about 1 and turbidity is less than or equal to about 1 NTU, or, in preferred embodiments, less than or equal to about 0.5 NTU. Contrary to accepted practice, the SDI is controlled to less than or equal to about 1, rather than the typically used value of less than 5.

The water treatment system and process provided by the present disclosure provides a recovery rate of about 80% or above. Specifically, the recovery rate is the ratio of the quantity of the permeate product stream produced to the quantity of the blow-down provided is greater than about 80%. In a preferred aspect of the disclosure, the recovery rate is about 85% or above. In a more preferred aspect of the disclosure, the recovery rate is about 90% or above. In the most preferred aspect of the disclosure, the recovery rate is about 95% or above.

Silt density index (SDI) is a means of quantifying the amount of particulate contamination in a water source. The silt density test described in ASTM 4189-07 is performed using a 0.45 micron, 47 mm diameter filter. The water to be tested is supplied to the filter at a constant pressure of 30 psi. The test involves measuring the time it takes to collect a 500 ml sample through the filter at the start of the test and comparing it with the time it takes to collect a 500 ml sample after water has flowed through the filter at 30 psi for 15 minutes. The resulting value, SDI-15, indicates the plugging of the membrane in percent-per-minute. The Silt Density Index test as defined in the ASTM standard is considered a valuable tool for assessing and monitoring the potential for fouling in water supplies for membrane separation systems. According to the present disclosure, the SDI of the blow-down into the membrane separation zone will be less than or equal to about 1.

Turbidity is a measure of the presence of colloidal matter in the water that remains suspended. Suspended matter in a water sample, such as clay, silt, or finely divided organic and/or inorganic matter will scatter the light from an incident light beam. The extent of scatter scattering may be expressed in Nephelometric turbidity units (NTU). According to the present disclosure, the turbidity of the blow-down into the membrane separation zone will be less than or equal to about 1 NTU, or, in more preferred embodiments, less than or equal to about 0.5 NTU.

In certain aspects of the disclosure, additional parameters of the water quality are controlled by the pretreatment of the feed water in the pretreatment zone. Such parameters include alkalinity, hardness, silica content, iron content and/or aluminum content and microbiologicals. By way of example, the pretreatment zone will provide the capability to control the feed water quality into the membrane separation zone to have the following parameters: alkalinity less than or equal to about 40 ppm (by CaCO₃); hardness less than or equal to about 100 ppm; silica content less than or equal to about 15 ppm in the water stream into the first membrane unit and less than or equal to about 50 ppm in the concentrate from the first membrane separation unit which is then treated in the second membrane separation unit.

The parameters to be measured and controlled will depend on the quality of the feed water from the blow-down and any additional source water. By way of example, where the source water or blow-down contains iron, the quality of the water sent to the membrane separation zone may be controlled such that the water contains less than or equal to about 0.5 ppm of iron. By way of a further example, where the source water or blow-down contains aluminum, the quality of the water sent to the membrane separation zone may be controlled such that the water contains less than or equal to about 0.5 ppm of aluminum.

The system of the present disclosure provides the ability to customize the water treatment based on the parameters of the feed water quality. Thus, the system may be set up such that the blow-down may be treated and recycled to the cooling equipment as at least a portion of the make-up water stream. Once the water quality of the blow-down water is determined, the pretreatment required to obtain the water quality parameters required for the membrane separation zone according to the present disclosure may be defined.

Alternatively, the water treatment system may be set up to treat water from a variety of sources, including blow-down, ground water, wastewater or other source, such as treated sewage effluent (TSE). The product water from the water treatment system may be used as at least a portion of make-up water for cooling equipment. In some embodiments, the ground water source may include water from a well located in proximity to the cooling equipment or cooling tower, such that additional water, for example, from a municipal source or other source, is not required. In another embodiment, the make-up water, for example, may include water condensed from the evaporate of cooling equipment, which water has been collected according to the methods disclosed herein.

Once the water quality of the water from these various sources is determined, the pretreatment required to obtain the water quality parameters required for the membrane separation zone according to the present disclosure may be defined.

By way of example, the water for pretreatment may be analyzed for the quality thereof by determining the alkalinity (as CaCO₃), hardness (as CaCO₃), silica (SiO₂), turbidity, iron content, aluminum content, temperature, free chlorine content, pH, TDS, conductivity microbiologicals, among others. Additional information on contaminants present in the source water may be defined, by way of example, such as the ionic species present which warrant removal or treatment, such as Ca²⁺, Na⁺, Mg²⁺, Fe²⁺, Mn²⁺, K⁺, Ba²⁺, Sr²⁺, Fe (total iron), NH₄⁺, Cl⁻, F⁻, SO₄²⁻, NO₃⁻, SiO₂, PO₄²⁻, HCO₃⁻, CO₃²⁻, S²⁻, or CO₂. The water quality may also be tested for volatile organic compounds (VOCs) or heavy metals which may exceed the desired limits.

The pretreatment zone may include any of the treatments for water known in the art. Such methods for treatment of water include use of a variety of chemicals, such as chlorine, anti-scalants, pH adjustors, etc., use of various particulate filter media such as active carbon or zeolite, use of ion exchange units, and a selection of filtration methods such as ultrafiltration or microfiltration.

These methods typically will be used in combination, depending on the quality of the feed water to be treated in the system. For some examples, VOCs can be treated by air stripping or carbon filtration, depending on the offending constituent concentration and the volume flow rate; hardness can be treated with anti-scalants or ion exchange resins; pH can be adjusted by acid or base dosing; and iron can be treated by oxidation or manganese greensand. Each constituent is considered on a case-by-case basis and treated accordingly. Consideration is always made for optimizing water reuse, operational and maintenance costs, efficacy of the water treatment and the impact of the process on the environment, again balancing the equation of sustainability and conserving water. According to the present disclosure, different combinations of membranes may be used in the membrane separation zone, depending partially on the materials desired to be removed at each step. The reverse osmosis membrane module unit is an array of parallel modules each of which consists of a pressure vessel containing one to several reverse osmosis membrane elements. Any number, combination, and arrangement can be used depending on their desired utilization.

For some examples, common membrane materials include polyamide thin film composites (TFC), cellulose acetate (CA) and cellulose triacetate (CTA) with the membrane material being spiral wound around a tube, or hollow fibres bundled together. Hollow fibre membranes have a greater surface area and hence capacity but are more easily blocked than spiral wound membranes. RO membranes are rated for their ability to reject compounds from contaminated water. A rejection rate (% rejection) is calculated for each specific ion or contaminant as well as for reduction of total dissolved solids (TDS). TFC membranes have superior strength and durability as well as higher rejection rates than CA/CTA membranes. They also are more resistant to microbial attack, high pH and high TDS. CA/CTA's have a better ability to tolerate chlorine. Sulfonated polysulfone membranes (SPS) are chlorine tolerant and can withstand higher pH's and are best used where the feed water is soft and high pH or where high nitrates are of concern. The performance of a system depends on factors such as membrane type, flow control, feed water quality, temperature and pressure. Also only part of the water entering the unit is useable; this is called the % recovery. This is affected by the factors listed above. For example the amount of treated water produced can decrease by about 1-2% for every 1 degree Celsius below the optimum temperature. Systems must be well maintained to ensure good performance with any fouling requiring cleaning maximizing the output of water. Biocides may be needed and the choice of biocide would depend on the membrane type, alternatively other filters may be required to remove chlorine from water to protect the life of the membranes. To this end a good treatment regime is needed and knowledge of the specific foulants so the optimum cleaning and maintenance chemicals can be chosen.

When reverse osmosis units are utilized in the membrane separation zone, the membrane separation zone typically will include at least two reverse osmosis units. The reverse osmosis treatment zone is downstream of the pretreatment zone and comprises a first reverse osmosis unit arranged to receive a pretreated water stream and pass the pretreated water stream through a first membrane unit to provide a first permeate stream and a first reject stream, and a second reverse osmosis unit arranged to receive the first reject stream and pass the first reject stream through a second membrane unit and provide a second permeate stream and a second reject stream.

In one embodiment, a nanofiltration zone is used rather than a reverse osmosis zone. Nanofiltration, in concept and operation, is much the same as reverse osmosis. The key difference is the degree of removal of monovalent ions such as chlorides. Reverse osmosis typically removes the monovalent ions at 98-99% level at 200 psi. Nanofiltration membranes' removal of monovalent ions typically varies between 50% to 90% depending on the material and manufacture of the membrane. For this reason, there are a variety of nanofiltration membranes available.

As with the reverse osmosis treatment zone described above, in the embodiment wherein a nanofiltration zone is used, the nanofiltration zone is downstream of the pretreatment zone and comprises a first nanofiltration unit arranged to receive a pretreated water stream and pass the pretreated water stream through a first membrane unit to provide a first permeate stream and a first reject stream, and a second nanofiltration unit arranged to receive the first reject stream and pass the first reject stream through a second membrane unit and provide a second permeate stream and a second reject stream.

The first permeate stream and the second permeate stream are combined in a collection zone to form a permeate product stream. The permeate product stream comprises high purity water which may be recycled to a make-up water stream for cooling equipment. The permeate product stream may be stored until needed. The purity of the water thus obtained advantageously may have a total dissolved solids (TDS) of about 6 or a conductivity of about 12 μmhos. Typically, TDS and conductivity will be reduced by approximately 95-99% of the source water's concentration.

The make-up water for a cooling tower should be of high purity to achieve peak performance in the cooling tower and to come as close as possible to zero discharge. In order to achieve this level of purity of water, the system of the present disclosure provides for lowering the TDS and virtually eliminating any hardness, turbidity, iron, silica and suspended solids.

By treating blow-down water and/or ground water to a high purity, the make-up water for cooling equipment, such as a cooling tower, is much higher in purity, thus improving the cooling tower's concentration ratio by as much as a factor of 10. The lower the conductivity/TDS of the make-up water, the higher the concentration ratio, which will translate into improved blow-down cycles, improved cooling tower efficiency and more water saved.

In a further aspect, the disclosure relates to a system and method for treating a blow-down to remove calcium carbonate (CaCO₃) and silica (SiO₂), comprised of pretreating the blow-down to produce a pretreated water stream having silica less than or equal to about 0.1 ppm and hardness of less than or equal to about 0.1 ppm on cooling tower blow-down, reducing hardness and resultant mineral scaling with high recovery rates and low biological fouling. This system and method may be used in combination with the system and method discussed above. When used in combination with the parameters described above, the quality of the water sent to the membrane separation zone in one aspect will be such that the water contains SDI less than or equal to about 1, a turbidity of less than or equal to about 1 NTU, silica less than or equal to about 0.1 ppm, and hardness less than or equal to about 0.1 ppm. In a further aspect, the quality of the water will include iron content less than or equal to about 0.1 ppm and aluminum content less than or equal to about 0.1 ppm.

The parameters of the quality of the water treated by the various systems of the present disclosure are tested throughout the systems in order to maintain control of the water quality. Monitoring the water quality through the system used is necessary since the feed water quality may be subject to change due to changes in the blow-down water properties or changes in the groundwater. Water quality parameters are measured on the inlet and outlet sides of a particular process (e.g., a nanofiltration unit). Typically, systems for on-line monitoring can include sensor networks for pH, ORP, TDS, conductivity, alkalinity dissolved oxygen (DO), chemical oxygen demand (COD), temperature, turbidity/suspended solids, nutrient parameters, ammonium, nitrate, interface level, process refractometry, total organic carbon.

The system of the disclosed disclosure may further advantageously be fully automated. The water treatment system of the present disclosure may employ any suitable monitoring and control components, assemblies and arrangements, to achieve desired operational conditions during processing of feed water for treatment effective to enable use of the water as make-up water for cooling equipment, such as a cooling tower. While laboratory analytical measurements are required to establish the proper treatment process, process control systems and on-line analytical instruments have been developed to assist the treatment plant operator in the control of the treatment process. Process automation can be separated into two types—continuous (or analog), and sequential (or logical). Flow control is an example of continuous or analog control, while the sequencing of valves in the backwash of a filter is logical control. The method of the current invention uses Supervisory Control And Data Acquisition (SCADA) for the remote control of pumping systems, valve and distribution of water. Additionally, SCADA is used in the current method in reference to the entire treatment process for automation, monitoring and remote control of the system. Alternatively, other monitoring and control modalities may be employed to modulate other system variables and parameters, to achieve beneficial operation of the water treatment system.

In one embodiment of the disclosure, at least a portion of the make-up water to the cooling equipment will include recycled water from the water treatment system and water recovered from the evaporate in the cooling equipment. In this aspect, a water treatment system for recovering water from the cooling equipment is provided. In one aspect, the water recovery includes optimizing water recovery from the cooling equipment using the water treatment system and water treatment process such that water utilized in such cooling equipment is recycled and re-used to the extent possible given the parameters of the system and cooling equipment employed. In one aspect, the cooling equipment is a cooling tower and the blow-down from the cooling tower is treated according to the water treatment methods disclosed herein. The evaporate from the operation of the cooling tower is collected and recycled, for example, as at least a portion of make-up water for the cooling tower, or other use.

In this embodiment, a water treatment system for recovering water from cooling equipment is provided comprising a cooling tower arranged to generate evaporate, utilize a make-up water stream and produce blow-down. The water treatment system further comprises a dehumidification zone coupled to the cooling tower and arranged to collect and condense evaporate generated by the cooling tower and a pretreatment zone arranged to receive the blow-down and to produce a pretreated water stream. A membrane separation zone is provided downstream of the pretreatment zone comprising a first membrane separation unit arranged to receive the pretreated water stream and pass the pretreated water stream through a first membrane unit to provide a first permeate stream and a first reject stream, and a second membrane separation unit arranged to receive the first reject stream and pass the first reject stream through a second membrane unit and provide a second permeate stream and a second reject stream.

A collection zone downstream of the membrane separation zone is provided and arranged to collect and combine the first permeate stream and the second permeate stream to provide a permeate product stream. The permeate product stream from the collection zone and the condensed evaporate from the dehumidification zone are combined and recycled to the cooling tower to provide at least a portion of the make-up water stream for the cooling tower.

In one aspect, the evaporate generated in the cooling tower is collected in a dehumidification zone. The dehumidification zone may include any means of collecting the moisture-containing air produced in the cooling tower and condensing and collecting the condensate or condensed evaporate. In one aspect, the system includes a fully self-contained, packaged unit which incorporates an air circulation fan and a totally CFC free refrigeration circuit. The fan draws air into the dehumidification zone passing it firstly across a refrigerated heat exchanger (evaporator). This cools the air, causing the moisture in the air-stream to be condensed onto the evaporator as water. The electrical driving energy, the energy recovered from the air-stream and the latent energy gained from the dehumidification process is combined and fed to the refrigeration condenser which is thereby heated. The cool dry air from the evaporator passes across this heated condenser before being passed back into the air stream, dry and warm. The water collected from the dehumidification zone is fed away to be reused as makeup water for the evaporative cooling tower. Such dehumidifiers are known in the art and may be adapted and utilized in a variety of designs depending on the cooling equipment or cooling tower and the operation thereof.

As shown in FIG. 1B, in an exemplary configuration of a cooling tower system using embodiments of the water treatment system and methods of the disclosure, the evaporate from the cooling tower 20 is captured and processed in dehumidifier equipment 22 to recover the water therefrom. The blow-down water and water from the evaporate is combined and treated according to methods as described herein in the water treatment area 24. The treated water may be stored in a high purity storage unit 26 and the water therein used as make up water for the cooling tower. The water treatment system may be used in embodiments where a ground water source or well is available. The ground water source may be added to the blow-down for water treatment. In such embodiments, additional make-up water may not be needed and the water treatment system provides substantially the entirety of the make-up water needed for the cooling equipment.

In one aspect, the water treatment system includes a disinfection zone. A disinfection zone may be used to further remove biological contaminates from the permeate product stream prior to recycling the permeate product stream to the cooling tower. Alternatively, the disinfection zone may be introduced into the circulating loop of the cooling tower. Such a zone could be, by way of example, introduced via Venturi injection method. In one aspect, the disinfection zone, may, for example, be a self-contained, portable water purification system using ozone, such as described in U.S. Pat. No. 6,824,695, incorporated by reference herein in its entirety. Other methods of removing biological contaminates known to those in the art may be used, such as UV treatment.

The advantages and features of the disclosure are further illustrated with reference to the following examples, which are not to be construed as in any way limiting the scope of the disclosure but rather as illustrative of embodiments of the disclosure in specific applications thereof.

### Example 1

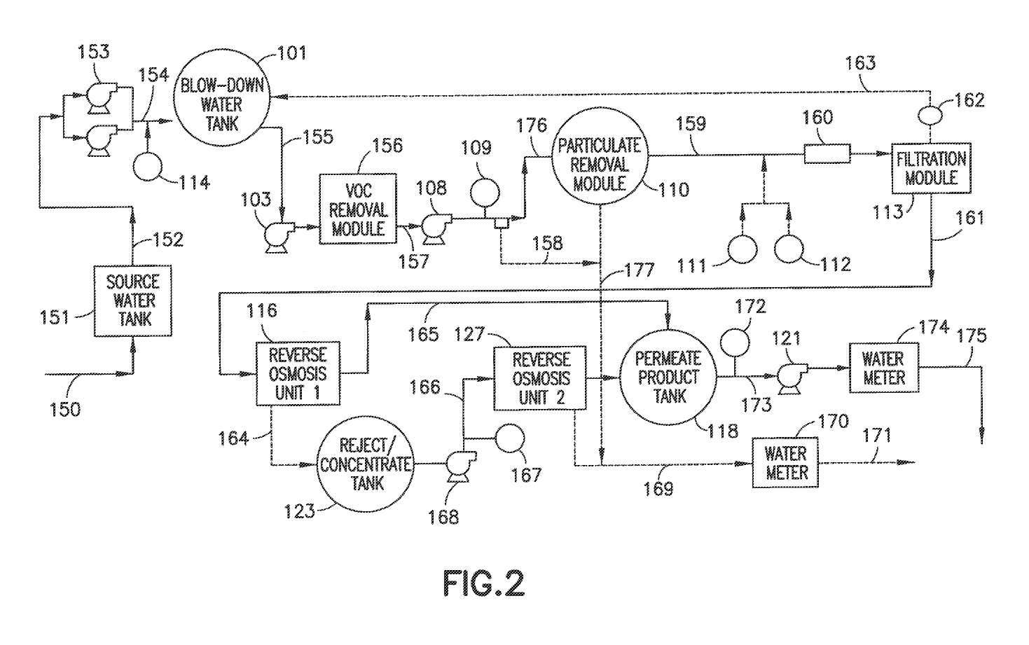

A water treatment system of the type shown schematically in FIG. 2 is employed to purify blow-down water from a cooling tower and water from an additional water source, such as ground water. In this illustrative example, any one or more of pretreatment modules may be utilized, depending on the water quality of the blow-down water and the additional water source.

According to FIG. 2, tank 151 is used to store source water and tank 101 is used to store blow-down water. The water in tank 151, by way of example, may be ground water brought in through line 150.

Feed pumps 153 are used to pump the feed water through line 152 from tank 151 and through line 154 from tank 101 into the system. A dosing pump 114 optionally provides chlorine or other chemical treatment to the feed water. The dosing pump typically is controlled by an ORP controller (not shown).

The combined feed water is pumped by pump 103 through line 155 into pretreatment module 156. Pump 103 is controlled by a float switch (not shown). Pretreatment module 156 is a module for the removal of volatile organic compounds (VOC). After the removal of VOCs from the feed water, pump 108, controlled by a pressure switch in conjunction with bladder tank 109, pumps the feed from pretreatment module 156 through line 157 and into pretreatment module 110 through line 176. The VOC's removed from pretreatment module 156 are removed through line 158.

Pretreatment module 110 is a filter for removing particulates. Such filters are known in the art, and may include, by way of example, a zeolite filter. The particulates removed from the feed stream are removed from the particulate removal module through line 177. After pretreatment in pretreatment module 110, the feed stream may be treated by antiscalant and/or dechlorination chemicals by way of dosing pumps 111 and 112. The feed stream in line 159 flows through a static mixer 160 and then into filtration module 113, where additional particulate materials are removed from the feed stream.

Pump 162 is used to drain the filtrate from the filtration module 113 through line 163 which is recycled to tank 101. The filtered feed stream flows through line 161 to reverse osmosis unit 116. The filtered feed stream is pumped through the reverse osmosis unit to obtain a permeate stream 165 and a reject or concentrate stream 164. The reject stream flows to tank 123 before being pumped by pump 168 (controlled by bladder tank 167) through line 166 to reverse osmosis unit 127. The reject from RO 116 passes through RO 127 to obtain a permeate stream 178 and a reject stream 169. The permeate from RO 116 flows through line 165 to permeate product tank 118, and mixes with the permeate stream 178 from RO 127. The reject stream from RO 127 flows through line 169 through water meter 170 to discard line 171. The product permeate from tank 118 flows through line 173 by use of pump 121 (controlled by bladder tank 172), through water meter 174 and is recycled through line 175 to the cooling equipment which provided the initial blow-down water in water tank 101.

### Example 2

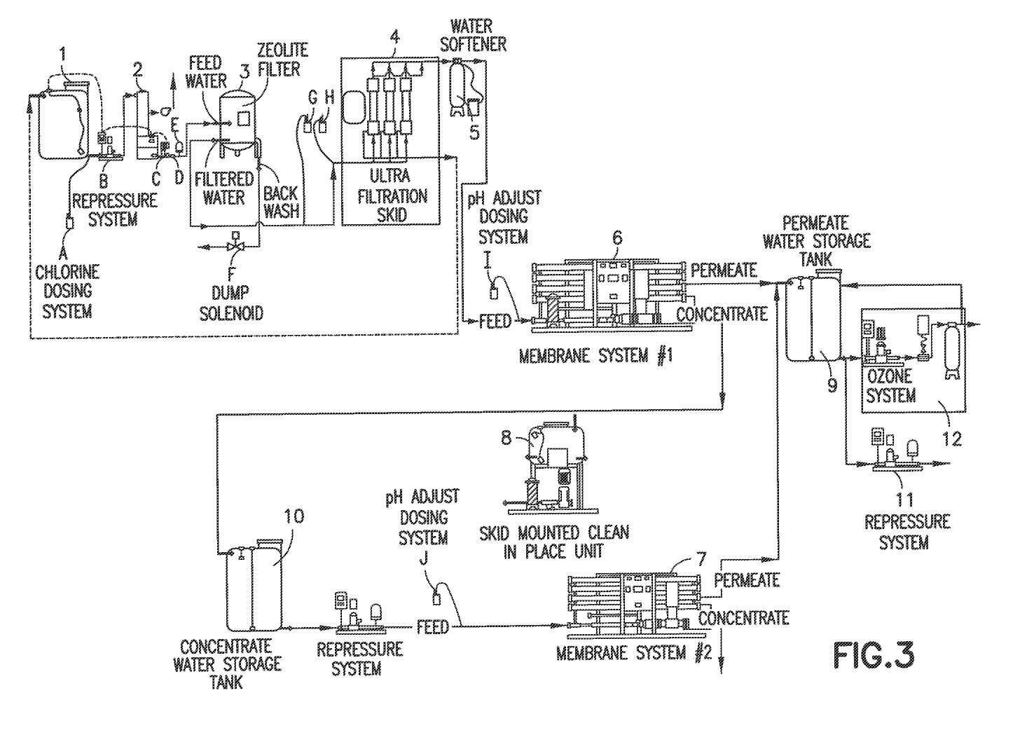

A system of the type shown schematically in FIG. 3 is employed to purify blow-down water from a cooling tower and recycle the purified water back to the cooling tower to be used as part of the make-up water flow for the tower. The system includes a 2500 gallon tank 1 for holding the blow-down water, an air stripper 2, zeolite filter 3, ultrafiltration unit 4, reverse osmosis unit 6 and reverse osmosis unit 7. The reject or concentrate produced in RO 6 is collected in permeate storage tank 9. The permeate produced in RO 6 and the permeate produced in RO 7 are collected in permeate storage tank 9.

The system operates such that once the start signal is active, RO (#6) inlet valve opens and dump valve (#F) if open, closes. The ultrafiltration (#4) skid then activates through n.o. dry contacts provided in the RO (#6) control panel. Antiscalant (#G) or softener (#5) with pH adjustment (#I) and bisulfite (#H) injection pumps start. Bladder tank (#E) begins to discharge through the system. A/r pressure switch (#D) senses low pressure and becomes active, starting process pump (#C).

One second after process pump (#C) starts, the blower in the air stripper (#2) starts. One second after the blower in the air stripper (#2) starts, feed pump (#B) starts. 45 seconds later, RO (#6) starts and begins processing water, filling permeate tank (#9) and concentration tank (#10).

A/r concentrate water from tank (#10) is fed into the RO unit 7 to be further processed to increase total system recovery.

The air stripper may be considered to be a stand-alone unit. If pressure switch (#D) is active, the unit will operate. Process pump (#C) is controlled by pressure switch (#D) and low sump level in the air stripper (#2). Blower in the air stripper (#2) runs when feed pump (#B) runs. Pump (#B) is controlled by high level and low level switch in the 2500 gallon tank (#1). An H—O-A switch/light is provided (feed, blower, and process pump) for each pump operation.

For the low sump level, there is a three second time delay before activation. For the high sump level (#2), there is a two second time delay before activation. Dump valve (#F) is active (open) when permeate tank (#9), concentrate tank (#10) and tank (#1) are full. An H-O-A switch/light function is provided for the dump valve (#F). Water passing through dump valve is processed through the air stripper 2 for VOC removal before entering city drain.

The zeolite filter processes water from process pump (#C). The zeolite filter will backwash using process water. The zeolite filter backwash signal will stop the RO (#6) operation.

Antiscalant injection pump (#G) or softener (#5) with pH adjustment (#1) and bisulfite injection pump (#H) will operate on an RO inlet solenoid signal. An inline static mixer (not shown) will ensure chemical mixing before entering the ultrafiltration unit.

Chlorine injection pump (#A) will be controlled by the end user's raw water transfer pump signal from an onsite 4000 gallon tank (not shown). An inline static mixer will ensure chemical mixing before the 2500 gallon buffer tank 1 to stop biological growth. An H-O-A switch/light function is provided for the dosing pump A.

The ultrafiltration unit (#4) will be controlled by dry contacts (relay) on the TESRO 10x840 RO unit (#6) inlet solenoid valve. The dry contact signal will close, sending a 24 v signal originating from the ultrafiltration skid to an input in the ultra filter control panel starting operation.

The RO unit (#6) will be controlled by a permeate tank (#9) high level switch in the permeate tank (#9) and the concentrate tank (#10) high level switch. The unit will also be controlled by low pressure auto reset, high pressure manual reset and zeolite filter (#3) backwash condition. When faults or lockouts occur, the system will shut down in reverse start order. The RO units include an on-skid clean-in-place system (#8) to include all valves, piping, pumps, etc., to be used to clean the RO unit 6 as well as the RO unit 7. Piping and valves are included to isolate the cleaning skid for cleaning.

The permeate distribution pump (#11) sends the product permeate to the point of use cooling towers. Stand-alone operation is controlled by a unit mounted pressure switch and tank mounted (#11) float control for low level pump protection. An H-O-A switch/light function is provided for the pump (#11).

The repress system (#11) operation is as follows:

A stand-alone operation controlled by unit mounted pressure switch (set @ 30/50) and tank mounted (#9) float control is provided for low level pump protection. An H-O-A switch/light function is provided for the pump.

A disinfection zone 12 may be used as shown in FIG. 3. The disinfection zone 12 in FIG. 3 is a stand-alone ozone system.

The parameters of operation of the air stripper 2, zeolite filter 3 and ultrafiltration unit 4 performed by the system of FIG. 3 are set forth in Table 1. The parameters of operation of reverse osmosis system RO 6 are set forth in Table 2. The parameters of operation of reverse osmosis system RO 7 are set forth in Table 3. Table 4 sets forth the water quality measurements taken during the operation of the system of FIG. 3. The conductivity, total dissolved solids, oxidation reduction potential, pH, SDI, turbidity and temperature were measured for tank 1, the feed to RO 6, the permeate from RO 6, the reject from RO 6, the feed to RO 7, the permeate produced in RO 7 and the reject from RO 7. The quality of water was also measured at the reject tank 10 and permeate tank 9.

TABLE 1

| | | DAY OF WEEK | | |
|---|---|---|---|---|
| | | TUES | WED | THURS |
| | | TIME OF DATA | | |
| | | RECORDED: | | |
| | Range | 11:00 | 11:00 | 3:00 |
| | Limits | am | AM | PM |
| AIR STRIPPER | | | | |
| AIR FLOW (cfm) Set for 800 | 700-900 | 850 | 850 | 850 |
| CFM | | | | |
| STATIC PRESSURE (ins of H2O) | 15″-25″ | 14 | 14 | 14 |
| Set for 20″-21″ | | | | |
| FEED PUMP INLET FLOW | 60-65 | 58 | 58 | 58 |
| (GPM) Set for 61 GPM | | | | |
| PROCESS PUMP OUTLET | 60-65 | 60 | 60 | 60 |
| FLOW (GPM) Set for 65 GPM | | | | |
| ZEOLITE FILTER | | | | |
| AIR PRESSURE to Stager | 75-90 | 88 | 88 | 88 |
| (10 psig over Max water press) | | | | |
| INLET PRESSURE (psig) | 50-80 | 70 | 72 | 71 |
| OUTLET PRESSURE (psig) | 50-80 | 62 | 64 | 63 |
| ZEOLITE FILTER ΔP | 10 MAX | 8 | 8 | 8 |
| ULTRA FILTER (UF) | | | | |
| INLET PRESSURE (psig) | 40-70 | 62 | 64 | 63 |
| OUTLET PRESSURE (psig) | 20-40 | 38 | 42 | 38 |
| ULTRA FILTER ΔP | 30 MAX | 24 | 22 | 25 |

TABLE 2

| | Range | | | |
|---|---|---|---|---|
| REVERSE OSMOSIS SYSTEM (RO#6) | Limits | | | |
| PREFILTER INLET PRESSURE (psig) | 20-40 | 38 | 42 | 38 |
| PREFILTER OUTLET PRESS (psig) LPS Set at 10 psi | 20-40 | 38 | 42 | 38 |
| PREFILTER PRESS DROP (Inlet-Outlet) (psig) ΔP | 5 MAX | 0 | 0 | |
| 1ST ARRAY FEED PRESS (psig) | 110-125 | 104 | 104 | 109 |
| 2ND ARRAY FEED PRESS (psig) | 100-115 | 98 | 98 | 104 |
| CONCENTRATE PRESS (psig) | 100-110 | 92 | 92 | 96 |
| 1st ARRAY PRESS DROP-(1st-2nd Array Feed) (psig) | 15 MAX | 6 | 6 | 5 |
| 2nd ARRAY PRESS DROP-(2nd-3rd Feed) (psig) | 15 MAX | 6 | 6 | 8 |
| SYSTEM ARRAY PRESS DROP-(1st-Conc Press) (psig) | 30 MAX | 12 | 12 | 13 |
| SYSTEM PERMEATE BACKPRESS (psig) | 10 MAX | 7 | 7 | 7 |
| SYSTEM PERMEATE FLOW (GPM) (norm 47) | 50 MAX | 43 | 42 | 43 |
| CONCENTRATE FLOW (GPM) (norm 14) | 13-15 | 14 | 14 | 14 |
| RECYCLE FLOW (GPM) | 0-10 | 0 | 0 | 0 |
| SYSTEM FEED FLOW (GPM) (Permeate + Concentrate) | 61 MAX | 57 | 56 | 57 |
| % RECOVERY (Perm Flow/Feed Flow) × (100) | 78.0% | 75.4% | 75.0% | 75.4% |
| FEEDWATER TDS-(PPM) | <500 | 344 | 352 | 367 |
| FEEDWATER pH | 7.5-8.5 | 8 | 7.4 | 8 |
| FEEDWATER TEMP-(F.) | 60 to 80 | 80 | 77 | 75 |
| PERMEATE TDS-(PPM) (norm <10) | <20 | 7.59 | 7.39 | 6.32 |
| PERMEATE pH | 5.0-6.5 | 5.8 | 5.1 | 5.5 |
| PERMEATE TEMP-(F.) | 60 to 80 | 80 | 78 | 76 |
| % REJECTION (Feed TDS − Perm TDS)/Feed TDS × (100) | 95%-99% | 97.8% | 97.9% | 98.3% |
| CONCENTRATE TDS (PPM) | <1500 | 1142 | 1131 | 1262 |
| RO6 A1PV1 Permeate TDS (PPM) | <10 | 5.52 | 5.07 | 4.8 |
| RO6 A1PV2 Permeate TDS (PPM) | <10 | 5.89 | 5.42 | 5.05 |
| RO6 A2PV3 Permeate TDS (PPM) | <20 | 19.12 | 17.29 | 16.7 |

TABLE 3

| | Range | | | |
|---|---|---|---|---|
| REVERSE OSMOSIS SYSTEM (RO#7) | Limits | | | |
| PREFILTER INLET PRESS (psig) | 40-60 | 51 | 53 | 54 |
| PREFILTER OUTLET PRESS (psig) | 30-50 | 50 | 53 | 54 |
| PREFILTER PRESS DROP (Inlet-Outlet) (psig) ΔP | 8 MAX | 1 | 0 | 0 |
| 1ST ARRAY FEED PRESS (psig) | 250 MAX | 225 | 232 | 235 |
| 2ND ARRAY FEED PRESS (psig) | 250 MAX | 225 | 230 | 232 |
| 3ND ARRAY FEED PRESS (psig) | 250 MAX | 219 | 225 | 228 |
| CONCENTRATE PRESS (psig) | 250 MAX | 211 | 218 | 221 |
| 1st ARRAY PRESS DROP-(1st-2nd Array Feed) (psig) | 6 MAX | 0 | 2 | 3 |
| 2nd ARRAY PRESS DROP-(2nd-3rd Feed) (psig) | 10 MAX | 6 | 5 | 4 |
| 3nd ARRAY PRESS DROP-(3rd-Concentrate) (psig) | 10 MAX | 8 | 7 | 7 |
| SYSTEM ARRAY PRESS DROP-(1st-Conc Press) (psig) | 20 MAX | 14 | 14 | 14 |
| SYSTEM PERMEATE FLOW (GPM) (norm 8-9) | 9 MAX | 6 | 5 | 5 |
| CONCENTRATE FLOW (GPM) (norm 15-16) | 14-18 | 14 | 14 | 14 |
| RECYCLE FLOW (GPM) | 0 to 10 | 0 | 0 | 0 |
| SYSTEM FEED FLOW (GPM) (Permeate + Concentrate) | 28 MAX | 20 | 19 | 19 |
| RO RECOVERY (%) (Perm Flow/Feed Flow) × (100) | 40% Max | 30.0% | 26.3% | 26.3% |
| FEEDWATER TDS-(PPM) | <2000 | 1153 | 1124 | 1209 |
| FEEDWATER pH (norm 8.2) | 7.5-8.5 | 7.9 | 7.5 | 7.85 |
| FEEDWATER TEMP-(F.) | 60 to 80 | 80 | 79 | 78 |
| PERMEATE TDS-(PPM) | <30 | 27.82 | 26.59 | 27.75 |
| PERMEATE pH | 5.0-6.5 | 5.9 | 5.7 | 5.8 |
| PERMEATE TEMP-(F.) | 60 to 80 | 80 | 80 | 78 |
| % REJECTION (Feed TDS − Perm TDS) Feed TDS × (100) | 95%-99% | 97.6% | 97.6% | 97.7% |
| CONCENTRATE TDS (PPM) | <2500 | 1554 | 1513 | 1565 |
| ANTISCALANT DOSING PUMP (RO#6) (Speed/Stroke) | 70/60 | 65/85 | 65/85 | 65/85 |
| ANTISCALANT DOSING PUMP (RO#7) (Speed/Stroke) | 35/60 | 90/90 | 90/90 | 90/90 |
| CHLORINE DOSING READING (ORP mV Set) | 550-650 | n/a | n/a | n/a |
| ORP READING into RO#6 (mV) | <300 | 155 | 217 | 138 |
| TOTAL RO6 PERMEATE PRODUCTION (GALS) | | 410,252 | 453,616 | 501,816 |
| TOTAL RO6 & RO7 PERMEATE PRODUCTION (GALS) | | 35,771 | 76,692 | 12,147 |

TABLE 4
WATER QUALITY MEASUREMENTS

| 2,500 GALLON RAW | | | | |
|---|---|---|---|---|
| WATER TANK | | | | |
| Conductivity | | 730 | 758 | 706 |
| Total Dissolved Solids (TDS) | <500 | 348 | 362 | 335 |
| Oxidation Reduction Potential | 550-650 | 163 | 169 | 170 |
| (ORP) | | | | |
| PH | 7.0 to 8.5 | 7.6 | 7.4 | 7.5 |
| SDI | | 9 | 7 | 8 |
| Turbidity | | 5 | 3 | 5 |
| Temperature (° F.) | 60 to 80 | 80 | 76 | 80 |
| RO #6 (FEED) | | | | |
| Conductivity | | 724 | 740 | 768 |
| Total Dissolved Solids (TDS) | <500 | 344 | 352 | 367 |
| Oxidation Reduction Potential | 200 | 155 | 217 | 138 |
| (ORP) | | | | |
| PH | 7.0 to 8.5 | 8 | 7.4 | 8 |
| SDI | ≦1 | 0.7 | 0.8 | 0.5 |
| Turbidity | ≦0.5 | 0.3 | 0.1 | 0.3 |
| Temperature (° F.) | 60 to 80 | 80 | 77 | 75 |
| RO #6 (PERMEATE) | | | | |
| Conductivity | | 16.67 | 16.21 | 13.85 |
| Total Dissolved Solids (TDS) | <10 | 7.59 | 7.39 | 6.32 |
| Oxidation Reduction Potential | 200 | 201 | 258 | 187 |
| (ORP) | | | | |
| PH | 6.0 to 8.0 | 5.8 | 5.1 | 5.5 |
| SDI | | 0.3 | 0.3 | 0.2 |
| Turbidity | | 0.1 | 0.1 | 0.1 |
| Temperature (° F.) | 60 to 80 | 80 | 78 | 76 |
| RO #6 (REJECT) | | | | |
| Conductivity | | 2640 | 2661 | 2707 |
| Total Dissolved Solids (TDS) | <1500 | 1317 | 1329 | 1356 |
| Oxidation Reduction Potential | 200 | 214 | 224 | 157 |
| (ORP) | | | | |
| PH | 6.0 to 8.0 | 7.65 | 7.4 | 7.8 |
| SDI | | 1.5 | 1.5 | 1.0 |
| Turbidity | | 0.5 | 0.5 | 0.5 |
| Temperature (° F.) | 60 to 80 | 80 | 79 | 76 |
| RO #7 (FEED) | | | | |
| Conductivity | | 2330 | 2270 | 2433 |
| Total Dissolved Solids (TDS) | <2000 | 1153 | 1124 | 1209 |
| Oxidation Reduction Potential | 200 | 165 | 208 | 135 |
| (ORP) | | | | |
| PH | 5.0 to 8.0 | 7.9 | 7.5 | 7.85 |
| SDI | | 1.5 | 1.5 | 1.0 |
| Turbidity | | 0.5 | 0.5 | 0.5 |
| Temperature (° F.) | 60 to 80 | 80 | 79 | 78 |
| RO #7 (PERMEATE) | | | | |
| Conductivity | | 60.77 | 57.1 | 60.41 |
| Total Dissolved Solids (TDS) | <20 | 27.82 | 26.59 | 27.75 |
| Oxidation Reduction Potential | 200 | 196 | 221 | 177 |
| (ORP) | | | | |
| PH | 5.0 to 8.0 | 5.9 | 5.7 | 5.8 |
| SDI | | 0.2 | 0.2 | 0.3 |
| Turbidity | | 0.1 | 0.1 | 0.1 |
| Temperature (° F.) | 60 to 80 | 80 | 80 | 78 |
| RO #7 (REJECT) | | | | |
| Conductivity | | 3084 | 3011 | 3108 |
| Total Dissolved Solids (TDS) | <3000 | 1554 | 1513 | 1565 |
| Oxidation Reduction Potential | 200 | 173 | 198 | 149 |
| (ORP) | | | | |
| PH | 5.0 to 8.0 | 7.8 | 7.65 | 7.8 |
| SDI | | 6 | 6 | 4 |
| Turbidity | | 2 | 2 | 2 |
| Temperature (° F.) | 60 to 80 | 81 | 81 | 79 |
| (Reject) TANK | | | | |
| Conductivity | | 2306 | 2285 | 2532 |
| Total Dissolved Solids (TDS) | <3000 | 1142 | 1131 | 1262 |
| Oxidation Reduction Potential | 200 | 185 | 187 | 176 |
| (ORP) | | | | |
| PH | 5.0 to 8.0 | 7.9 | 7.8 | 7.75 |
| SDI | | 6 | 6 | 4 |
| Turbidity | | 2 | 2 | 2 |
| Temperature (° F.) | 60 to 80 | 80 | 80 | 79.5 |
| (Permeate) TANK | | | | |
| Conductivity | | 36.1 | 34.53 | 88.14 |
| Total Dissolved Solids (TDS) | <20 | 16.35 | 15.28 | 40.57 |
| Oxidation Reduction Potential | 200 | 221 | 208 | 227 |
| (ORP) | | | | |
| PH | 6.0 to 8.0 | 6.1 | 6.2 | 3.6 |
| SDI | | 0.2 | 0.2 | 0.2 |
| Turbidity | | 0.1 | 0.1 | 0.1 |
| Temperature (° F.) | 60 to 80 | 80 | 79 | 77 |

### Example 3

In one example, a zero liquid discharge wastewater pretreatment system based on high pH and reverse osmosis or nanofiltration membrane technology, has been successfully completed for performance testing on cooling tower blow down, reducing hardness and resultant mineral scaling with high recovery rates and low biological fouling. The combined design process permits up to or exceeding 10 cycles of concentration without harmful effect to the cooling towers. Effluent from the treatment plant is monitored for conductivity and recycled back to the cooling towers as feed water, minimizing blow-down volume. The reject, concentrated in silica, is sent to the sanitary drain or a brine disposal/drying pond, achieving zero liquid discharge at the most economic cost. The combination of this highly efficient process with the evaporation pond takes advantage of the small reject volume at high recovery rate, greater than 90%. Such systems and methods are especially beneficial in semi-arid conditions such as in desert conditions. Recycle/reuse is also needed for operations in dry desert areas where water is scarce. Blow-down at the plant is pretreated using acidification, degasification, and clarification.

When designing a membrane separation system, the natural saturation limits of various salts should not be exceeded, otherwise these salts would precipitate and scale the reverse osmosis and/or nanofiltration membranes. Silica is the most common process limiting constituent. At conditions of 77° F. and pH between 6.5 to 7.5, the solubility of silica is 120 ppm. If silica in reject water exceeds more than 120 ppm under the above conditions, scaling of membranes would occur. Thus, if the water feeding into a membrane separation system has silica of 50 ppm, maximum concentration possible under normal conditions of conventional reverse osmosis and/or nanofiltration would be reached within just 2 cycles of concentration. This would translate into a possible permeate recovery of approximately 50% from the feed water.

The process of one aspect of the disclosed process is designed to increase the silica solubility in the membrane reject water to 1500 ppm and beyond. With the increased solubility, recoveries beyond 90% can be successfully achieved, under the conditions previously described.

Conventional RO, which runs at near neutral or slightly acidic pH, requires antiscalant additives. Concentration cycles may be limited because of the hardness and silica content. Other zero liquid discharge options include a brine concentrator/crystallizer with or without RO, although such choices are more energy intensive. Because high recovery membrane separation system design elements run at high pH, hardness is removed eliminating mineral scaling. Additional advantages of running at high pH include higher silica solubility, which permits higher recovery. Increased silica ionization enhances silica rejection and produces purer permeate, permitting higher concentration cycles and more economic use of water. In addition, fouling microorganisms are either killed or prevented from propagating at high pH levels, eliminating high pH cleaning. Acid cleaning is reduced because the system runs at low levels of hardness. In one example, during performance testing of a water treatment system according to the disclosure, cooling tower blow-down had hardness of 450 ppm to 550 ppm and alkalinity of 50 ppm to 60 ppm as calcium carbonate. System inlet silica was around 40 ppm to 50 ppm, but less than 0.1 ppm in the pretreated water stream, having been concentrated to 400 ppm to 500 ppm in the reject. Hardness in the pretreated water stream was less than 0.1 ppm. The pH was raised to above 10, wherein the silica solubility increases exponentially.

While the water treatment system and method have been described with respect to various aspects, implementations and embodiments, it will be appreciated that any of such aspects, implementations and embodiments can be present in any combination with any other aspects, implementations and embodiments of the disclosure. The disclosure therefore is to be regarded as comprehending all permutations and combinations of compatible features individually or specifically described, in corresponding aggregations of such features. It further is to be recognized that any one or more of the individual features specifically disclosed herein may be selectively excluded from any other feature or combination of features disclosed herein, in specific implementations of the water treatment system and method of the present disclosure, as further embodiments thereof.

While the disclosure has been has been described herein in reference to specific aspects, features and illustrative embodiments of the disclosure, it will be appreciated that the utility of the disclosure is not thus limited, but rather extends to and encompasses numerous other variations, modifications and alternative embodiments, as will suggest themselves to those of ordinary skill in the field of the present disclosure, based on the disclosure herein. Correspondingly, the disclosure as hereinafter claimed is intended to be broadly construed and interpreted, as including all such variations, modifications and alternative embodiments, within its spirit and scope.

1. A method for treating blow-down to remove contaminants, comprising:
pretreating the blow-down to produce a pretreated water stream having an SDI less than or equal to about 1 and a turbidity of less than or equal to about 1 NTU;
flowing the pretreated water stream into a first membrane separation unit to obtain a first permeate stream and a first reject stream;
flowing the first reject stream into a second membrane separation unit to obtain a second permeate stream and a second reject stream; and
combining the first permeate stream and the second permeate stream to form a permeate product stream,
wherein the ratio of the quantity of the permeate product stream produced to the quantity of the blow-down provided is greater than about 80%; and
wherein the second reject stream is not recycled to the first or the second membrane separation unit.

2. The method of claim 1, wherein the first membrane separation unit and the second membrane separation unit are reverse osmosis units.

3. The method of claim 1, wherein the first membrane separation unit and the second membrane separation unit are nanofiltration units.

4. The method of claim 1, wherein the pretreating step further comprises pretreating the blow-down to produce a pretreated water stream having a silica content less than or equal to about 0.1 ppm and a hardness less than or equal to about 0.1 ppm.

5. The method of claim 4, further comprising raising the pH of the pretreated water stream to above 10.

6. The method of claim 1, wherein the blow-down comprises blow-down water from cooling equipment.

7. The method of claim 6, further comprising recycling the permeate product stream to the cooling equipment to provide at least a portion of a make-up water stream for the cooling equipment.

8. The method of claim 1, wherein the ratio of the quantity of the permeate product stream produced to the quantity of the blow-down provided is greater than about 85%.

9. The method of claim 1, wherein the ratio of the quantity of the permeate product stream produced to the quantity of the blow-down provided is greater than about 90%.

10. The method of claim 1, wherein the ratio of the quantity of the permeate product stream produced to the quantity of the blow-down provided is greater than about 95%.

11. The method of claim 1, wherein the pretreated water stream has a turbidity of less than or equal to about 0.5 NTU.

12. A method for treating blow-down to remove calcium and silica, comprising:
pretreating the blow-down to produce a pretreated water stream having silica content less than or equal to about 0.1 ppm and hardness of less than or equal to about 0.1 ppm;
flowing the pretreated water stream into a first membrane separation unit to obtain a first permeate stream and a first reject stream;
flowing the first reject stream into a second membrane separation unit to obtain a second permeate stream and a second reject stream; and
combining the first permeate stream and the second permeate stream to form a permeate product stream,
wherein the ratio of the quantity of the permeate product stream produced to the quantity of the blow-down provided is greater than about 80%; and wherein the second reject stream is not recycled to the first or the second membrane separation unit.

13. The method of claim 12, wherein the pretreated water stream further has an iron content less than or equal to about 0.1 ppm and aluminum content less than or equal to about 0.1 ppm.

14. A method of treating water comprising:
pretreating the water to produce a pretreated water stream having an SDI less than or equal to about 1 and a turbidity of less than or equal to about 1 NTU;
flowing the pretreated water stream into a first membrane separation unit to obtain a first permeate stream and a first reject stream;
flowing the first reject stream into a second membrane separation unit to obtain a second permeate stream and a second reject stream; and
combining the first permeate stream and the second permeate stream to form a permeate product stream,
wherein the ratio of the quantity of the permeate product stream produced to the quantity of the water provided is greater than about 80%; and wherein the second reject stream is not recycled to the first or the second membrane separation unit; and
wherein the water comprises blow-down, ground water, wastewater or a combination thereof.

15. The method of claim 14, further comprising, prior to pretreating the water, analyzing the water by determining at least one of the qualities selected from the group consisting of alkalinity, hardness, silica content, turbidity, iron content, aluminum content, temperature, free chlorine content, pH, total dissolved solids content, conductivity, volatile organic compound content, heavy metal content, ionic species content and microbiologicals content.

16. The method of claim 15, wherein the pretreating comprises air stripping, particulate removal or a combination thereof.

17. The method of claim 15, wherein the pretreating comprises treatment with chlorine, anti-scalants, pH adjustors or a combination thereof.

18. The method of claim 15, wherein the pretreated water stream has an alkalinity less than or equal to about 40 ppm.

19. The method of claim 18, wherein the pretreated water stream has a hardness less than or equal to about 100 ppm.

20. The method of claim 15, further comprising raising the pH of the pretreated water stream to above 10.

21. The method of claim 15, wherein the total dissolved solids is determined prior to pretreatment and the total dissolved solids in the permeate product stream is reduced 95-99%.

22. The method of claim 21, wherein the conductivity is determined prior to pretreatment and the conductivity in the permeate product stream is reduced 95-99%.

23. The method of claim 14, wherein the water comprises blow-down and the blow-down comprises blow-down water from cooling equipment.

24. The method of claim 23, further comprising recycling the permeate product stream to the cooling equipment to provide at least a portion of a make-up water stream for the cooling equipment.

25. The method of claim 14, wherein the water comprises blow-down and ground water.

26. The method of claim 14, wherein the water comprises blow-down and wastewater.

27. The method of claim 14, wherein the first membrane separation unit and/or the second membrane separation unit are reverse osmosis units.

28. The method of claim 14, wherein the first membrane separation unit and/or the second membrane separation unit are nanofiltration units.

29. The method of claim 14, wherein the pretreated water stream has a turbidity of less than or equal to about 0.5 NTU.
